(19) United States
(12) Patent Application Publication
(10) Pub. No.: US 2026/0290884 A1
(43) Pub. Date: Sep. 24, 2026

(54) SOLID ELECTROLYTE MEMBRANES AND ALL-SOLID-STATE RECHARGEABLE BATTERIES

(71) Applicant: SAMSUNG SDI CO., LTD., Yongin-si, Gyeonggi-do (KR)

(72) Inventors: Eungyeong LEE, Yongin-si, Gyeonggi-do (KR); Jaejun LEE, Yongin-si, Gyeonggi-do (KR); Jaemin KIM, Yongin-si, Gyeonggi-do (KR); Gunwook LEE, Yongin-si, Gyeonggi-do (KR); Sieun LEE, Yongin-si, Gyeonggi-do (KR); Myoungki MIN, Yongin-si, Gyeonggi-do (KR)

(73) Assignee: SAMSUNG SDI CO., LTD., Yongin-si, Gyeonggi-do (KR)

(21) Appl. No.: 18/880,403

(22) PCT Filed: Jan. 4, 2024
(86) PCT No.: PCT/KR2024/000229

§ 371 Date: Dec. 31, 2024

(30) Foreign Application Priority Data
Mar. 10, 2023 (KR) 10-2023-0032011

(51) Int. Cl. H01M 10/0562; H01M 10/052

(52) U.S. Cl. CPC H01M 10/0562; H01M 10/052; H01M 2300/0068

(57) ABSTRACT

Disclosed are a solid electrolyte membrane, and an all-solid-state rechargeable battery including the same, the solid electrolyte membrane including a sulfide-based solid electrolyte and a hydrogenated nitrile butadiene rubber binder, wherein a residual double bond in the hydrogenated nitrile butadiene rubber binder are less than 1 mol % based on 100 mol % of the hydrogenated nitrile butadiene rubber binder.

### TECHNICAL FIELD

Solid electrolyte membranes and all-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries.

### DISCLOSURE

By applying a binder that is highly flexible and has excellent adhesive strength while being soluble in a low-polarity solvent with low reactivity and a sulfide-based solid electrolyte, a flexible, high-adhesion, low-resistance solid electrolyte membrane is provided while implementing high ionic conductivity, and an all-solid-state rechargeable battery with excellent processability and improved overall performance such as cycle-life characteristics is provided.

In an embodiment, a solid electrolyte membrane includes a sulfide-based solid electrolyte and a hydrogenated nitrile butadiene rubber binder, wherein a content of a residual double bond in the hydrogenated nitrile butadiene rubber binder is less than 1 mol % based on 100 mol % of the hydrogenated nitrile butadiene rubber binder.

In another embodiment, an all-solid-state rechargeable battery includes a positive electrode, a negative electrode, and the aforementioned solid electrolyte membrane between the positive electrode and the negative electrode.

A solid electrolyte membrane according to an embodiment can achieve excellent performance due to its excellent processability, high ionic conductivity, flexibility, and low adhesive strength. All-solid-state rechargeable batteries that use this have excellent electrochemical performance, including cycle-life characteristics.

### DESCRIPTION OF THE DRAWINGS

FIGS. 1 and 2 are cross-sectional views schematically showing all-solid-state rechargeable batteries according to embodiments.

FIG. 3 is a photograph showing the solid electrolyte membrane of Example 1 bent with a finger to evaluate the flexibility of the solid electrolyte membrane.

FIG. 4 is a photograph showing the solid electrolyte membrane of Example 2 bent with tweezers to evaluate the flexibility of the solid electrolyte membrane.

FIG. 5 is a photograph showing the solid electrolyte membrane of Comparative Example 3.

FIG. 6 is a photograph of the slurry for forming a solid electrolyte membrane of Example 1.

FIG. 7 is a photograph of the slurry for forming a solid electrolyte membrane of Example 4.

FIG. 8 is a graph showing cycle-life characteristics of the all-solid-state rechargeable battery cells of Example 1, Example 2, and Comparative Example 5.

FIG. 9 is a photograph taken one week after the binder of Comparative Example 1 was added to the solvent.

FIG. 10 is a graph showing the 1.0 C discharge capacity for the all-solid-state rechargeable battery cells of Examples 3 and 4 and Comparative Example 2.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Solid Electrolyte Membrane

In order to increase the energy density and reduce the resistance of all-solid-state rechargeable batteries, it is essential to manufacture and apply a thin film-type solid electrolyte membrane. However, the current limited slurry solvent and binder technology has limitations in thinning highly reactive sulfide-based solid electrolytes. For example, because highly polar solvents are highly reactive with sulfide-based solid electrolytes, there is a limitation that a slurry for forming a solid electrolyte membrane must use a solvent with low polarity. In addition, a binder that can dissolve in a solvent with low polarity should be used, but binders such as polyvinylidene fluoride are difficult to apply to solid electrolyte membranes because they only dissolve in solvents with high polarity. Accordingly, a technology using an acrylic binder that can be dissolved in a solvent with low polarity has been proposed, but, while the acrylic binder has excellent adhesive properties, it lacks flexibility, and thus, solid electrolyte membranes using it have problems such as breaking during the process stage or cracks occurring inside the battery. A nitrile-butadiene rubber (NBR) binder has higher flexibility than the acrylic binder, but when manufactured in thin thicknesses, they have problems with poor moisture stability, mechanical properties, and processability.

In an embodiment, a solid electrolyte membrane includes a sulfide-based solid electrolyte and a hydrogenated nitrile butadiene rubber (H-NBR) binder. The H-NBR refers to nitrile butadiene rubber (NBR) in which hydrogen is added or hydrogenated to reduce the content of residual double bonds (RDB), and according to an embodiment, H-NBR is characterized in that the content of residual double bonds is less than 1 mol % based on 100 mol % of H-NBR.

According to an embodiment, H-NBR is well soluble in low-polarity solvents such as isobutyryl isobutyrate, octyl acetate, and xylene, which have low reactivity with sulfide-based solid electrolytes, and is therefore suitable for use in slurry for forming a solid electrolyte membrane. In addition, it exhibits high flexibility, appropriate strength, and excellent adhesive strength.

A solid electrolyte membrane according to an embodiment of the present invention using an H-NBR binder exhibits high flexibility and appropriate strength, high ionic conductivity, low resistance, and high adhesive strength, and also has excellent processability. The solid electrolyte membrane can improve the overall performance, including cycle-life characteristics, of an all-solid-state battery by suppressing problems such as breaking or shattering due to changes in the thickness of the electrode or lithium dendrites during charge and discharge.

The content of residual double bonds in the above H-NBR binder may be, for example, 0.001 mol % to 0.9 mol %, or 0.01 mol % to 0.5 mol %, based on 100 mol % of hydrogenated nitrile butadiene rubber. These H-NBR binders have higher flexibility than the acrylic binder and better moisture stability, mechanical properties and processability than the NBR binder.

The H-NBR binder may be included in an amount of less than 2 wt %, for example, 0.1 wt % to 1.5 wt %, or 0.1 wt % to 1.0 wt % based on 100 wt % of the solid electrolyte membrane. By including the H-NBR binder in the above content range, high flexibility and strength, ionic conductivity, and adhesive strength of the solid electrolyte membrane can be realized simultaneously. For example, when the H-NBR binder is included in an amount of 2 wt % or more, the solid electrolyte membrane may have poor ionic conductivity or poor processability.

The H-NBR binder includes a nitrile unit and a butadiene unit. In an embodiment, the content of nitrile units in H-NBR may be from 12 mol % to 28 mol %, for example from 15 mol % to 25 mol %, based on 100 mol % of the H-NBR binder. When the content of the nitrile unit satisfies the above range, the solid electrolyte film exhibits appropriate flexibility, suppressing the phenomenon of breaking, while at the same time implementing high adhesive strength and low resistance characteristics. For example, if the content of nitrile units is too low, the strength of the binder polymer is lowered, resulting in poor adhesive strength, and thus, increasing the amount of binder used results in increased resistance. Conversely, if the content of nitrile units is too high, the density of the binder polymer may increase, the strength may increase, the brittleness may increase, the flexibility may decrease, the resistance may increase, and the ionic conductivity may decrease.

The glass transition temperature of the H-NBR binder may be, for example, −45° C. to −30° C. Additionally, the weight average molecular weight of the H-NBR binder may be 100,000 g/mol to 1,000,000 g/mol.

The solid electrolyte membrane may further include a residual solvent in addition to the sulfide-based solid electrolyte and the H-NBR binder. The solid electrolyte membrane can be manufactured through a process of applying a slurry for forming a solid electrolyte membrane, including a solid electrolyte, a binder, and a solvent, to a substrate and then drying the same, and during the drying process, a trace amount of the solvent can remain in the solid electrolyte membrane without evaporating.

The residual solvent may be a low-polarity solvent having low reactivity with the sulfide-based solid electrolyte, and may include, for example, isobutyryl isobutyrate, octyl acetate, xylene, toluene, heptane, hexane, benzene, or a combination thereof. For example, the residual solvent may include isobutyryl isobutyrate, octyl acetate, or a combination thereof. Solvents such as isobutyryl isobutyrate and octyl acetate are non-lethal toxic, have little reactivity with sulfide-based solid electrolytes, and have relatively high flash points, so that they may be solvents with excellent work safety, environmental friendliness, human safety, and processability. By applying these solvents and H-NBR binder, it is possible to manufacture a flexible, highly adhesive, and low-resistance solid electrolyte membrane with high ionic conductivity.

The residual solvent may be included in an amount of less than or equal to 0.1 wt %, for example 0.0001 wt % to 0.09 wt %, 0.0005 wt % to 0.05 wt %, or 0.001 wt % to 0.01 wt % based on 100 wt % of the solid electrolyte membrane.

The solid electrolyte membrane may further include an organic dispersant. The organic dispersant serves to ensure phase stability of the slurry for forming a solid electrolyte film and to help uniform spreadability and film formation.

The organic dispersant includes an alkyl group having 8 to 30 carbon atoms, and may include, for example, an alkyl ester, an alkyl amine, an alkyl ether, an alkyl phosphate, an alkene, an alkyl acrylate, or a combination thereof.

The organic dispersant may be included in an amount of less than or equal to 1 wt %, for example, 0.01 wt % to 1 wt %, 0.05 wt % to 0.9 wt %, or 0.1 wt % to 0.6 wt % based on 100 wt % of the solid electrolyte membrane. When the organic dispersant is included within the above content range, the phase stability and dispersibility of the slurry can be improved. For example, if the organic dispersant exceeds 1 wt %, the ionic conductivity of the solid electrolyte membrane may decrease or the resistance may increase.

The sulfide-based solid electrolyte may include, for example, Li₂S—P₂S₅, Li₂S—P₂S₅—LiX (wherein X is a halogen element, for example I, or CI), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S-B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte including such an argyrodite-type sulfide-based solid electrolyte may have high ionic conductivity close to the range of 10-4 to 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The solid electrolyte membrane may include an oxide-based inorganic solid electrolyte in addition to a sulfide-based solid electrolyte. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, Zr, or a combination thereof; and x is an integer of 1 to 10), or a mixture thereof.

The solid electrolyte is in the form of particles and may have an average particle diameter (D50) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte may be small particles having a size of 0.1 μm to 1.9 μm, large particles having a size of 2.0 μm to 5.0 μm, or a mixture thereof. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

Meanwhile, the average particle diameter (D50) of the solid electrolyte included in the solid electrolyte membrane may be larger than the average particle diameter (D50) of the solid electrolyte included in the positive electrode. In this case, the energy density of the all-solid-state rechargeable battery may be maximized while increasing the mobility of lithium ions to improve the overall performance. For example, the average particle diameter (D50) of the solid electrolyte included in the positive electrode may be 0.1 μm to 1.9 μm, or 0.1 μm to 1.0 μm, and the average particle diameter (D50) of the solid electrolyte included in the solid electrolyte membrane may be 2.0 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery.

On the other hand, the solid electrolyte membrane may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, Lil, LiB(C₂O₄)₂, LiBF₄, LiBF₃(C₂F₅), lithium bis(oxalato)borate (LiBOB), lithium oxalyldifluoroborate (LiODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte membrane may be 0.1:99.9 to 90:10, for example 10:90 to 90:10, 20:80 to 90:10, 30:70 to 90: 10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### All-Solid-State Rechargeable Battery

In an embodiment, an all-solid-state rechargeable battery includes a positive electrode, a negative electrode, and the aforementioned solid electrolyte membrane positioned between the positive electrode and the negative electrode.

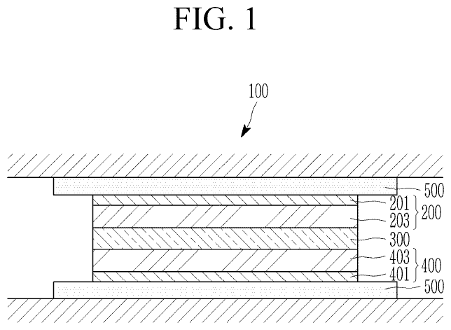

FIG. 1 is a cross-sectional view of an all-solid-state rechargeable battery according to an embodiment. Referring to FIG. 1, the all-solid-state rechargeable battery 100′ has a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. Here, the solid electrolyte layer 300 is the aforementioned solid electrolyte membrane. The all-solid-state rechargeable battery 100′ may further include at least one elastic sheet 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

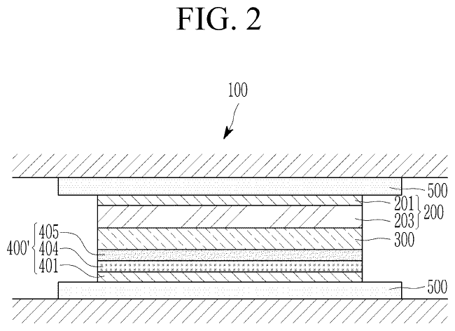

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

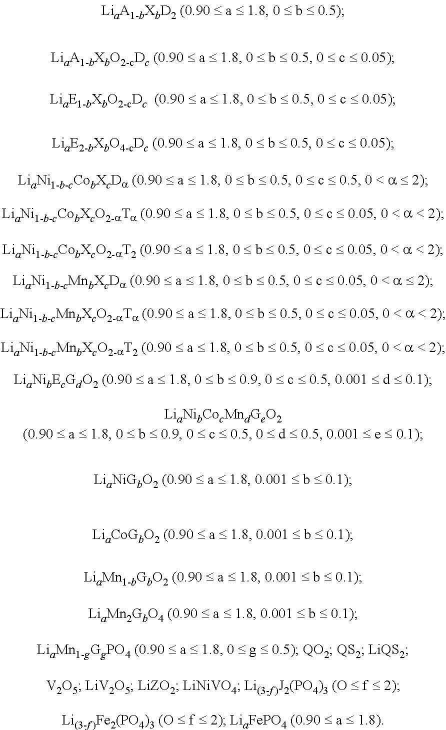

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

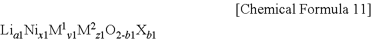

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6<x1≤1, 0≤y1≤0.4, and 0≤z1≤0.4 or 0.8≤x1≤1, 0≤y1≤0.2, and 0≤z1≤0.2.

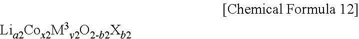

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

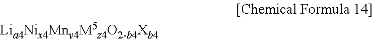

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

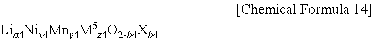

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Here, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, detailed descriptions therefor is omitted.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Binder

The binder serves to adhere the positive electrode active material particles to each other and also to properly attach the positive active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Manufacturing of Solid Electrolyte Membrane

A binder solution was prepared by dissolving an H-NBR binder having a residual double bond content of less than 1 mol %, a nitrile unit content of 16 mol %, a weight average molecular weight of 5.5×10⁵ g/mol, and a glass transition temperature of −43° C. in an octyl acetate solvent. Subsequently, an organic dispersant and an argyrodite-type solid electrolyte of Li₆PS₅Cl (D50=3 μm) was added thereto and then, stirred to prepare a slurry. The slurry included 98.7 wt % of the solid electrolyte, 1.0 wt % of the binder, and 0.3 wt % of the organic dispersant. The slurry was bar-coated on a release PET film and then, dried at room temperature to form a solid electrolyte membrane.

### 2. Manufacturing of Positive Electrode

85 wt % of LiNi_{0.8}Co_{0.15}Mn_{0.05}O₂ coated with Li₂O—ZrO₂ as a positive electrode active material, 13.5 wt % of Li₆PS₅Cl as a lithium argyrodite type solid electrolyte, 1.0 wt % of polyvinylidene fluoride as a binder, and 0.5 wt % of carbon nanotube as a conductive material were mixed to prepare a positive electrode composition. The prepared positive electrode composition was coated on a positive electrode current collector by using a bar coater and then, dried and compressed to manufacture a positive electrode.

### 3. Manufacturing of Negative Electrode

After preparing an Ag/C composite by mixing carbon black with a primary particle diameter (D50) of about 30 nm and silver (Ag) with an average particle diameter (D50) of about 60 nm in a weight ratio of 3:1, 0.25 g of the composite was added to 2 g of an NMP solution including 7 wt % of a polyvinylidene fluoride binder and then, mixed to prepare a negative electrode coating layer composition. The negative electrode coating layer composition was coated on a nickel foil current collector with a bar coater and then, vacuum-dried to prepare a precipitation-type negative electrode having a negative electrode coating layer on the current collector.

4. Manufacturing of All-solid-state Battery Cell

A unit stack cell was manufactured by stacking a positive electrode, a solid electrolyte membrane, and a negative electrode in that order, and then placing this in a laminate film and subjecting it to warm isostatic pressing (WIP) at 80° C. and 500 MPa for 30 minutes to manufacture an all-solid-state rechargeable battery cell.

### Example 2

A solid electrolyte membrane and an all-solid-state rechargeable battery cell were manufactured substantially in the same manner as in Example 1 except that an H-NBR binder having a residual double bond content of less than 1 mol %, a nitrile unit content of 24 mol %, a weight average molecular weight of 5.5×105 g/mol, and a glass transition temperature of −35° C. was used.

### Example 3

A solid electrolyte membrane and an all-solid-state rechargeable battery cell were manufactured substantially in the same manner as in Example 1 except that the content of the H-NBR binder was changed to 1.3 wt % to prepare a slurry including 98.4 wt % of the solid electrolyte, 1.3 wt % of the binder, and 0.3 wt % of the organic dispersant.

### Example 4

A solid electrolyte membrane and an all-solid-state rechargeable battery cell were manufactured substantially in the same manner as in Example 1 except that the content of the H-NBR binder was changed to 1.8 wt % to prepare a slurry including 97.9 wt % of the solid electrolyte, 1.8 wt % of the binder, and 0.3 wt % of the organic dispersant.

### Comparative Example 1

A solid electrolyte membrane and an all-solid-state rechargeable battery cell were manufactured substantially in the same manner as in Example 1 except that an NBR binder having a residual double bond content of 3.5±1.0 mol % was used.

### Comparative Example 2

A solid electrolyte membrane and an all-solid-state rechargeable battery cell were manufactured substantially in the same manner as in Example 1 except that the content of the H-NBR binder was changed 2.5 wt % to prepare a slurry including 97.2 wt % of the solid electrolyte, 2.5 wt % of the binder, and 0.3 wt % of the organic dispersant.

### Comparative Example 3

A solid electrolyte membrane and an all-solid-state rechargeable battery cell were manufactured substantially in the same manner as in Example 1 except that an H-NBR binder having a residual double bond content of less than 1 mol % and a nitrile unit content of 30 mol % was used.

### Comparative Example 4

A solid electrolyte membrane and an all-solid-state rechargeable battery cell were manufactured substantially in the same manner as in Example 1 except that 99 wt % of the solid electrolyte and 1.0 wt % of the binder alone without using the organic dispersant were used to prepare a slurry.

### Comparative Example 5

A solid electrolyte membrane and an all-solid-state rechargeable battery cell were manufactured substantially in the same manner as in Example 1 except that the acrylic binder was used instead of the H-NBR binder.

### Evaluation Example 1: Flexibility Evaluation of Solid Electrolyte Membrane

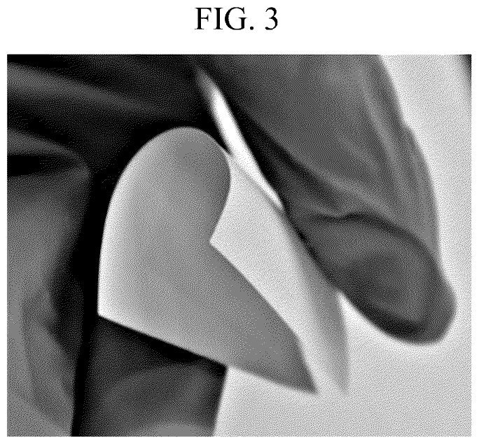

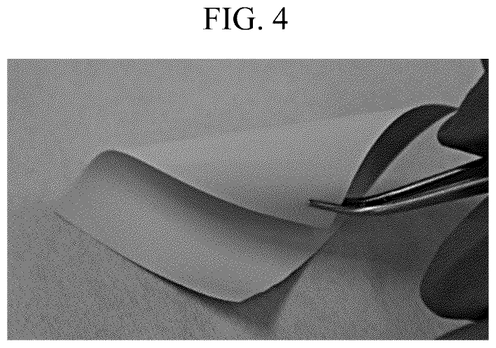

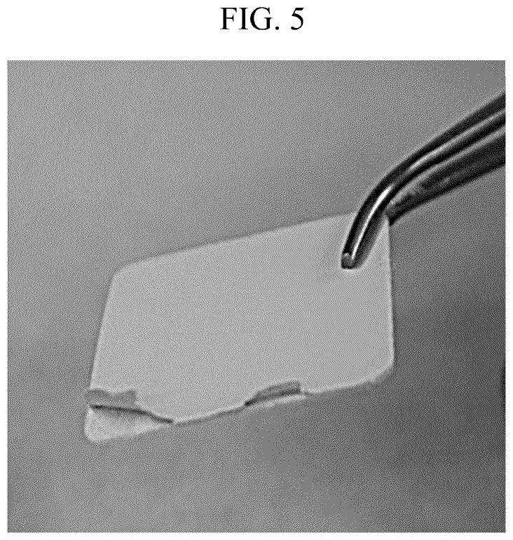

In order to check flexibility of the solid electrolyte membranes with naked eyes, a photograph of the solid electrolyte membrane of Example 1 bent with a finger is shown in FIG. 3, a photograph of the solid electrolyte membrane of Example 2 bent with a tweezer is shown in FIG. 4, and a photograph of the solid electrolyte membrane of Comparative Example 3 is shown in FIG. 5.

Referring to FIGS. 3 to, the solid electrolyte membranes according to Examples 1 and 2 were confirmed to be very flexible, but the solid electrolyte membrane of Comparative Example 3 exhibited an increase in strength and thus a decrease in flexibility.

### Evaluation Example 2: Evaluation of Ionic Conductivity of Solid Electrolyte Membrane

The solid electrolyte membranes according to Examples 1 and 2 were measured with respect to ionic conductivity, and the results are shown in Table 1. Herein, the ionic conductivity was measured with respect to each of the solid electrolyte membranes through electrochemical impedance spectroscopy (EIS). Specifically, the ionic conductivity of the solid electrolyte membranes was calculated by obtaining a Nyquist plot through the impedance analysis.

TABLE 1

| | |
|---|---|
| Example 1 | Example 2 |

| | | |
|---|---|---|
| Double bond content in binder | <1% | <1% |
| Nitrile unit content in binder | 16% | 24% |

| | | | | |
|---|---|---|---|---|
| T_{g} | −43° | C. | −35° | C. |
| Ionic conductivity of solid | 0.333 | mS/cm | 0.633 | S/cm |
| electrolyte membrane | | | | |

Referring to Table 1, the solid electrolyte membranes according to Examples 1 and 2 turned out to realize high ionic conductivity.

### Evaluation Example 3: Slurry Dispersibility

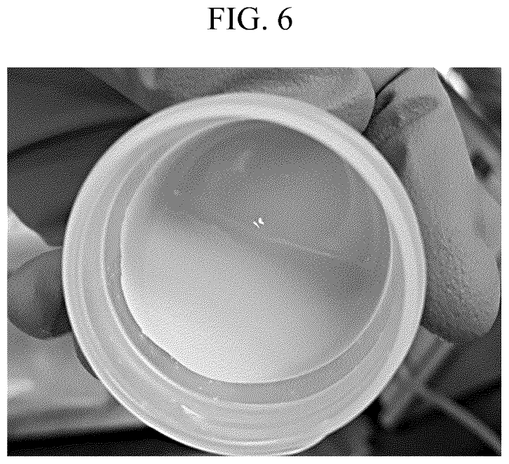

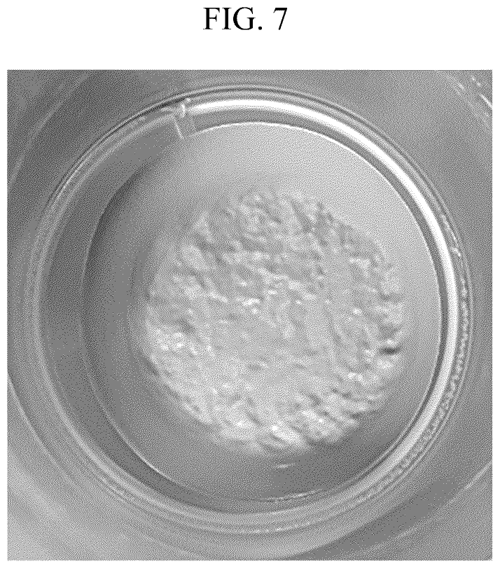

A photograph of the slurry for forming the solid electrolyte membrane according to Example 1 is shown in FIG. 6, and a photograph of the slurry for forming the solid electrolyte membrane according to Comparative Example 4 is shown in FIG. 7.

Example 1 exhibited excellent slurry dispersibility, but Comparative Example 4 exhibited no excellent slurry dispersibility, and even when the slurry for forming the solid electrolyte membrane according to Comparative Example 4 was coated into a membrane, the membrane turned out to have no good quality.

### Evaluation Example 4: Evaluation of Battery Performance of all-Solid-State Rechargeable Battery Cell

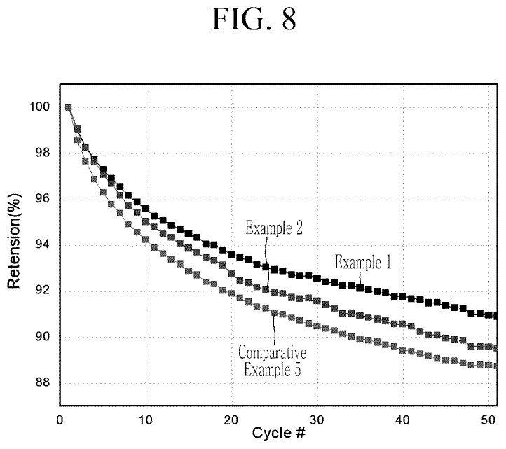

The all-solid-state rechargeable battery cells according to Examples 1 and 2 and Comparative Example 5 were charged to an upper limit voltage of 4.25 V at a constant current of 0.1 C and discharged to a cut-off voltage 2.5 V at 0.1 C at 45° C. for initial charge and discharge. Subsequently, the cells were 50 times or more repeatedly charged and discharged at 0.33 C within a voltage range of 2.5 V to 4.25 V at 45° C. to calculate discharge capacity at each cycle to initial discharge capacity, and the results are shown as capacity retention in FIG. 8.

Referring to FIG. 8, the all-solid-state rechargeable battery cells of Examples 1 and 2, compared with the cell of Comparative Example 5, exhibited improved cycle-life characteristics.

### Evaluation Example 5

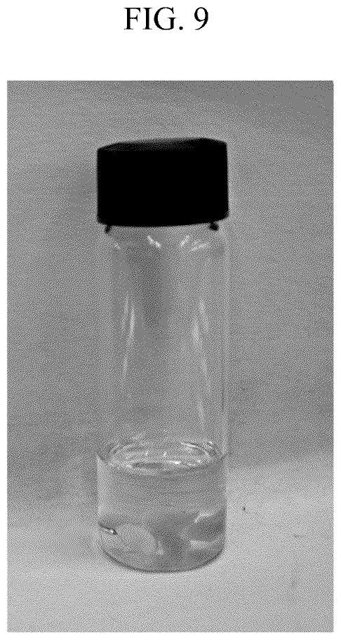

The NBR binder having a residual double bond content of 3.5±1.0 mol %, which was used in Comparative Example 1, exhibited deteriorated dissolubility for the octyl acetate solvent, and accordingly, a wet slurry manufacturing method was evaluated to be unapplicable thereto. FIG. 9 shows a photograph taken on week after immersing 2 wt % of the NBR binder of Comparative Example 1 in the octyl acetate solvent. Referring to FIG. 9, the binder of Comparative Example 1 after a week was confirmed to be not dissolved in the solvent.

### Evaluation Example 6

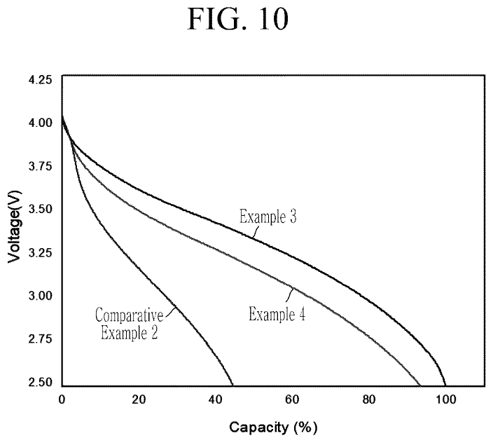

The all-solid-state rechargeable battery cells of Examples 3 and 4 and Comparative Example 2 were charged to an upper limit voltage of 4.25 V at a constant current of 0.1 C and discharged to a cut-off voltage of 2.5 V at 1.0 C at 45° C. to measure 1.0 C discharge capacity, and the discharge capacity (a horizontal axis) to a voltage (a vertical axis) is shown in FIG. 10. Referring to FIG. 10, Comparative Example 2 including 2 wt % or more of the binder exhibited inferior 1 C discharge capacity. When the binder was used in an excessive amount, it was understood that an increase in resistance generated by the binder resulted in disadvantageous rate capability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

<Description of Symbols>

| | |
|---|---|
| 100: all-solid-state battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. A solid electrolyte membrane, comprising
a sulfide-based solid electrolyte and a hydrogenated nitrile butadiene rubber binder,
wherein a content of a residual double bond in the hydrogenated nitrile butadiene rubber binder is less than 1 mol % based on 100 mol % of the hydrogenated nitrile butadiene rubber binder.

2. The solid electrolyte membrane as claimed in claim 1, wherein
a content of a residual double bond in the hydrogenated nitrile butadiene rubber binder are 0.001 mol % to 0.9 mol % based on 100 mol % of the hydrogenated nitrile butadiene rubber binder.

3. The solid electrolyte membrane as claimed in claim 1, wherein
the hydrogenated nitrile butadiene rubber binder is included in an amount of less than 2 wt % based on 100 wt % of the solid electrolyte membrane.

4. The solid electrolyte membrane as claimed in claim 1, wherein
the hydrogenated nitrile butadiene rubber binder is included in an amount of 0.1 wt % to 1.5 wt % based on 100 wt % of the solid electrolyte membrane.

5. The solid electrolyte membrane as claimed in claim 1, wherein
the hydrogenated nitrile butadiene rubber binder is included in an amount of 0.1 wt % to 1.0 wt % based on 100 wt % of the solid electrolyte membrane.

6. The solid electrolyte membrane as claimed in claim 1, wherein
a content of a nitrile unit in the hydrogenated nitrile butadiene rubber binder is 12 mol % to 28 mol % based on 100 mol % of the hydrogenated nitrile butadiene rubber binder.

7. The solid electrolyte membrane as claimed in claim 1, wherein
a content of a nitrile unit in the hydrogenated nitrile butadiene rubber binder is 15 mol % to 25 mol % based on 100 mol % of the hydrogenated nitrile butadiene rubber binder.

8. The solid electrolyte membrane as claimed in claim 1, wherein
a glass transition temperature of the hydrogenated nitrile butadiene rubber binder of −45° C. to −30° C.

9. The solid electrolyte membrane as claimed in claim 1, wherein
a weight average molecular weight of the hydrogenated nitrile butadiene rubber binder is 100,000 g/mol to 1,000,000 g/mol.

10. The solid electrolyte membrane as claimed in claim 1, wherein
the solid electrolyte membrane further comprises a residual solvent,
the residual solvent comprises isobutyryl isobutyrate, octyl acetate, xylene, toluene, heptane, hexane, benzene, or a combination thereof, and
the residual solvent is included in an amount of less than or equal to 0.1 wt % based on 100 wt % of the solid electrolyte membrane.

11. The solid electrolyte membrane as claimed in claim 1, wherein
the solid electrolyte membrane further comprises an organic dispersant,
the organic dispersant comprises an alkyl group having 8 to 30 carbon atoms and comprises an alkyl ester, an alkyl amine, an alkyl ether, an alkyl phosphate, an alkene, an alkyl acrylate, or a combination thereof, and
the organic dispersant is included in an amount of less than or equal to 1 wt % based on 100 wt % of the solid electrolyte membrane.

12. The solid electrolyte membrane as claimed in claim 1, wherein
the sulfide-based solid electrolyte comprises argyrodite-type sulfide.

13. The solid electrolyte membrane as claimed in claim 1, wherein
the sulfide-based solid electrolyte is in a form of particles and the average particle diameter (D50) of the particles is 0.1 μm to 5.0 μm.

14. An all-solid-state rechargeable battery, comprising
a positive electrode,
a negative electrode, and
the solid electrolyte membrane of claim 1 between the positive electrode and the negative electrode.

15. The all-solid-state rechargeable battery as claimed in claim 14, wherein
the negative electrode comprises a current collector and a negative electrode coating layer disposed on the current collector and including a lithiophilic metal, a carbon material, or a combination thereof, and
a lithium metal layer formed by charging between the current collector and the negative electrode coating layer.

16. The all-solid-state rechargeable battery as claimed in claim 14, wherein
the positive electrode comprises a current collector and a positive electrode active material layer located on the current collector and including a positive electrode active material,
wherein the positive electrode active material comprises lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.

17. The all-solid-state rechargeable battery as claimed in claim 14, wherein
the positive electrode comprises a current collector and a positive electrode active material layer on the current collector,
the positive electrode active material layer comprises a positive electrode active material and a sulfide-based solid electrolyte, and
65 wt % to 99 wt % of the positive electrode active material and 1 wt % to 35 wt % of solid electrolyte are included based on 100 wt % of the positive electrode active material and the solid electrolyte.
